(19) United States
(12) Patent Application Publication
(10) Pub. No.: US 2002/0060301 A1
(43) Pub. Date: May 23, 2002

(54) Apparatus for measuring scattered radiation

(76) Inventor: Markus Probst, Peissenberg (DE)

Correspondence Address: SMITH-HILL AND BEDELL, 12670 N W BARNES ROAD, SUITE 104, PORTLAND, OR, 97229

(21) Appl. No.: 09/811,059

(22) Filed: Mar. 15, 2001

(30) Foreign Application Priority Data
Mar. 15, 2000 (DE) 100 12 613 . 8

(51) Int. Cl. G01N 21/49

(52) U.S. Cl. 250/574

(57) ABSTRACT

An apparatus for performing scattered radiation measurements in fluids comprising a sender (1)-for example a light source-to directly emit radiation into the fluid (5), a detector (2) to measure scattered radiation in the fluid, at least one separator (4) that is provided between the fluid and the sender and between the fluid and the detector, and that allows radiation to pass through it, wherein, at least one optical deflection element (8, 9) is provided between the sender and the separator and/or between the detector and the separator, in order to deflect the emitted beam/the scattered beam toward the perpendicular onto the separator. This scattered radiation measuring apparatus is characterized by having a very compact design.

The present invention relates to a device to perform measurements of scattered radiation in fluids, in particular liquids.

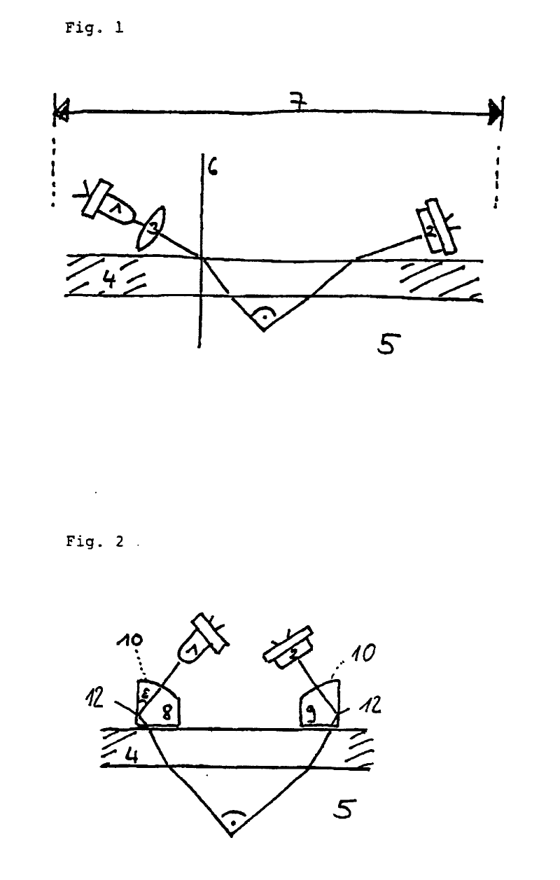

For such measurements of scattered radiation, which as a rule are performed in the range of visible light or in the near-infrared range, a sender-as a rule a light source-a detector, and a separator are provided. The separator shields the sender and the detector from the liquid. The separator allows the radiation to pass through it and is generally comprised of a pane of glass, a pane of sapphire, or a transparent plastic pane. An arrangement of this type is shown in FIG. 1. The light coming from the light source 1 is aligned in parallel paths by an optical lens 3, and after passing through the glass pane 4, it travels into the liquid to be measured. The scatter radiation occurring in the liquid as a result of parameters that indicate impurity-turbidity, for example-is measured in the detector 2, and the path of detected scattered radiation is also represented. Since the radiation is deflected relative to the perpendicular when it enters the glass pane 4, and since, as a result of the lower difference in refractive power between the pane and the medium compared to the difference between the air and the pane, this process occurring at the boundary between the pane and the test medium is not canceled out, and since the radiation is refracted away from the perpendicular when it leaves the glass pane 4 traveling in the direction of the detector 2, the result is an apparatus whose length 7 is relatively large. This in turn means that the detected radiation must be oriented at an angle of approximately 90 degrees relative to the beam of light that is projected into the liquid 5.

The object of the present invention is therefore to design an apparatus to measure scattered radiation in a more compact way. This object is achieved by the elements of claim 1. Preferred embodiments of the invention are set forth in the dependent claims.

The invention provides at least one optical deflection element in the radiation path between the sender and the separator and/or between the separator and the detector. This element causes the beam to deviate toward the perpendicular. In this way, the sender and the detector can be disposed closer to one another. As a result, the entire apparatus has more compact dimensions.

A further advantage of the novel apparatus is that fewer reflection losses occur than would be the case in the prior-art apparatus of FIG. 1. In the prior-art apparatus, the sender as well as the detector must be disposed at an extremely obtuse angle relative to the pane, which entails a certain amount of reflection when the beam enters the pane 4 and also entails a certain amount of reflection within the pane 4 when the beam passes from the pane 4 into the space in front of the detector 2. As a consequence of the deflection element, the emitted light beam or the received beam of scattered light can enter or exit, respectively, through an optical surface of the deflection element, thus minimizing the percentage of emitted and detected light that is reflected.

The deflection element is preferably configured as a reflecting prism, which is preferably located on one side in intimate contact with the separator. The deflection element can also be embodied as a single piece integral with the separator. In any case, the contact between the deflection element and the separator should be as intimate as possible to avoid deflections of the beam of light between these two components and to ensure that the beam of light passes from the deflection element into the separator and vice versa largely without being deflected. Therefore, the deflection element is preferably comprised of a material whose index of refraction is at least similar to that of the separator. The deflection element may be comprised of one or more parts.

The exit/entry surface of the deflection element facing the detector as well as facing the light source is preferably embodied as a non-planar surface. The surface may be aspherical, arcuate, or spherical. In this way, the light source or the detector can be disposed in such a way that it turns about the deflection point within a given angular range, which ensures that the light source always passes through the entry/exit surface perpendicularly. This type of arrangement provides a relatively large amount of freedom for positioning the sender/detector. An optical deflection element is preferably provided in the radiation path between the sender and the separator as well as in the radiation path between the separator and the detector. In this way the beam is guided in an optimal manner before it enters the fluid, and the scattered light radiated from the fluid is also guided in an optimal manner.

As already stated, the deflection element possesses a surface in the radiation path entry/exit area that is oriented essentially perpendicular to the direction of radiation. The deflection can occur in the deflection element at one or more deflection surfaces. If the angles of incidence onto the deflection surfaces are so large that there is a risk that the beam will pass through the element to the outside, the deflection surfaces may be reflectively coated on the outside in order to ensure that the beam is forced to reflect back into the inside of the deflection element. In addition, a plurality of deflection surfaces can be used, so that the angle of incidence of the beam onto the surface can be kept as small as possible, which in turn allows the beam to be guided in such a way that total reflection occurs at the deflection surfaces.

The invention is illustrated below based on examples shown in the drawings in FIGS. 2 to 6. FIG. 1 shows a typical prior-art arrangement of components as already described in the introduction to the description. The drawing shows:

FIG. 2 a side view of an apparatus for measuring scattered light having two optical deflection elements,

FIG. 3 the apparatus of FIG. 2 seen from the fluid side,

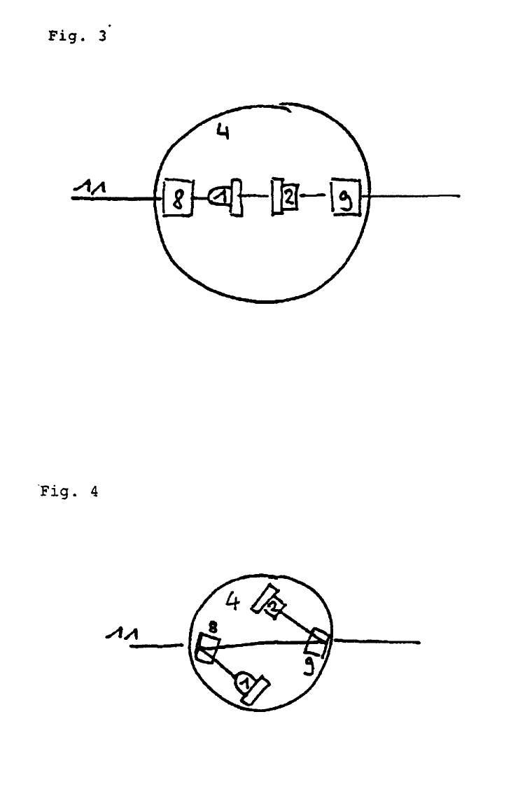

FIG. 4 a modified apparatus compared to FIG. 3, in which the light source and the detector are moved out of the plane of the light beam in the fluid,

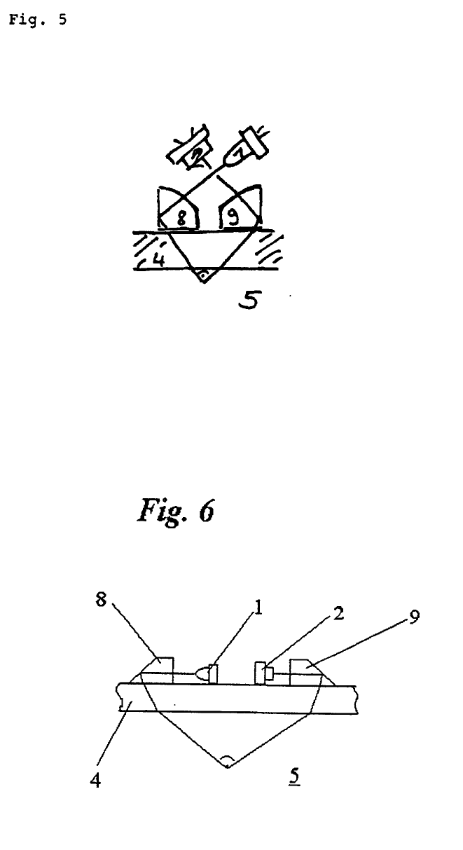

FIG. 5 an apparatus having two optical deflection elements and crossing beams, and

FIG. 6 a side view of an optical apparatus with the light source and the detector aligned parallel to the separator.

FIG. 2 shows a measurement apparatus of the invention that is much more compact compared to that shown in FIG. 1. In it, an optical deflection element in the form of a reflecting prism 8, 9 is provided in the radiation path between the light source 1 and the separating pane 4 and between the separating pane 4 and the detector 2. The prisms 8, 9 have a spherical surface 10 on their sides facing the light source 1 and the detector 2, respectively. The light source 1 and the detector 2 are arranged in such a way that their optical axis intersects the spherical centerpoint of the respective surface. As the drawing clearly shows, the apparatus in FIG. 2 is much more compact than the prior-art apparatus in FIG. 1.

The representation shown in FIG. 2 is repeated in FIG. 3 in a view from the fluid side 5. One can see an approximately circular separating pane 4 behind which the first and second reflecting prisms 8, 9 are located, as are the light source 1 and the detector 2. Even though this apparatus are [sic: is] much more compact than the prior-art apparatuses as shown in FIG. 1, this apparatus is somewhat elongated in the horizontal direction.

For this reason, in the apparatus shown in FIG. 4, the light source 1 and the detector 2 are disposed in positions that are offset from the radiation plane of the beam of light in the fluid. It is readily apparent that this provides a much smaller measuring window.

A further reduction in the dimensions of the entire apparatus can be achieved by crossing the paths of the beams from the light source 1 and the scattered light 2 received by the detector in a lateral projection. This once again allows the reflecting prisms 8, 9 to be disposed closer to each other, so that a correspondingly smaller separator can be used. In this embodiment, the measuring point for measuring turbidity can be positioned in the fluid extremely close to the separating pane 4.

FIG. 6 once again shows the same apparatus comprising a light source 1, detector 2, separating pane 4, and reflecting prisms 8, 9, where the light source and the detector are aligned parallel to the separating pane 4. This causes the entire measuring apparatus to have a very low depth perpendicular to the plane of the measuring window. Of course, here too the light source 1 and the detector 2 can be moved relative to the beam path, as shown in FIG. 4, which not only results in a low depth but also a very compact dimension along the plane of the measuring window 4.

Needless to say, the various features relating to the arrangement of the light source, detector, and reflecting prisms can be combined with one another. The deflecting surface within the prism does not need to be a flat surface, it may also be a curved surface, which can be used to focus a somewhat diffused light beam onto detector 2 when, in particular, the light beam passes from the fluid to detector 2. In addition to their primary function of deflection, the reflecting prisms can also be used to combine the beams of light or to separate them into parallel beams of light.

1. An apparatus for performing scattered radiation measurements in fluids, comprising a sender (1), for example a light source to directly emit radiation into the fluid (5), a detector (2) to measure scattered radiation in the fluid, at least one separator (4) that is located between the fluid and the sender/detector and that allows the radiation to pass through it, wherein, at least one optical deflection element (8, 9) is provided between the sender and the separator and/or between the detector and the separator, in order to deflect the emitted beam/the scattered beam toward the perpendicular onto the separator.

2. The apparatus of claim 1, wherein, a first deflection element (8) is provided between the sender and the separator, and a second deflection element (9) is provided between the separator and the detector.

3. The apparatus of one of the above claims, wherein, the deflection element (8, 9) is comprised of a reflecting prism.

4. The apparatus of claims 3, wherein, the reflecting prism (8, 9) has a radiation entry/exit surface (10) which is configured as a nonplanar aspherical surface in the deflection element.

5. The apparatus of one of the above claims, wherein, the optical deflection element (8, 9) has an entry surface/exit surface (10) that is disposed in such a way that the center beam enters/exits perpendicularly, and a deflection surface that is disposed in such a way that the center beam is reflected in the interior of the deflection element.

6. The apparatus of claim 5, wherein the entry surface/exit surface (10) is curved in such a way that the beams emitted by the sender or leaving the deflection element travel in the deflection element parallel to the optical axis of the surface.

7. The apparatus of claim 5 or 6, wherein total reflection is achieved at the deflection surface by properly selecting the angle of incidence (a) and the material.

8. The apparatus of claim 5, 6 or 7, wherein the entry surface/exit surface (10) is a spherical surface.

9. The apparatus of one of the above claims, wherein the deflection element (8, 9) is provided to achieve parallel alignment and deflection of the emitted beam/incident scattered beam.

10. The apparatus of one of the above claims, wherein the surfaces of the optical deflection elements are comprised of a circular cylindrical or spherical surface and of flat surfaces.

11. The apparatus of one of the above claims, wherein the optical deflection element (8, 9) is disposed directly on the separator (10).

12. The apparatus of one of the above claims, wherein the optical deflection elements and the separator are configured as units that are connect to one another or comprise an integral part.

13. The apparatus of one of the above claims, wherein the sender (1) and detector (2) are not disposed in the same plane as the optical deflection elements (8) and (9) (FIG. 4).

14. The apparatus of one of the above claims, wherein the sender (1), receiver (2) and the optical components (8, 9) lie in the same plane, and the light paths cross (FIG. 5).
